(19) United States
(12) Patent Application Publication
(10) Pub. No.: US 2025/0326116 A1
(43) Pub. Date: Oct. 23, 2025

(54) System and Method for Controlling Robotic Manipulator with Self-Attention Having Hierarchically Conditioned Output

(71) Applicant: Mitsubishi Electric Research Laboratories, Inc., Cambridge, MA (US)

(72) Inventors: Radu Ioan Corcodel, Brookline, MA (US); Haohong Lin, Pittsburgh, PA (US)

(73) Assignee: Mitsubishi Electric Research Laboratories, Inc., Cambridge, MA (US)

(21) Appl. No.: 18/640,621

(22) Filed: Apr. 19, 2024

(51) Int. Cl. B25J 9/16

(52) U.S. Cl. CPC B25J 9/1661; B25J 9/1697

(57) ABSTRACT

A method for controlling a robotic manipulator according to a task comprises accepting a feedback signal including a sequence of multi-modal observations of a state of execution of the task. The multi-modal observations are processed with a neural network having a self-attention module with a hierarchically conditioned output to produce a skill of the robotic manipulator and an action conditioned on the skill. The neural network is trained in a supervised manner with demonstration data to produce a sequence of skills and a corresponding sequence of actions for the actuators of the robotic manipulator to perform the task. The method further comprises determining one or more control commands for the one or more actuators based on the produced action and submitting the one or more control commands to the one or more actuators causing a change of the state of execution of the task.

### TECHNICAL FIELD

The present disclosure relates generally to a robotic assembly, and more specifically to a robotic assembly based on a neural network having a self-attention module with a hierarchically conditioned output.

### BACKGROUND

Robotic assembly automation has developed in two major areas. The first is the work planning area, which focuses on planning possible assembly sequences based on the constraints of the assembly task while the second area is the field of assembly control and motion planning. There are several challenges associated with robust execution of robotic assembly tasks. Contact-rich robotic manipulation of objects is a complex task due to its contact-rich and long-horizon nature. Also, the contextual purpose of the objects and the associated subtasks that must be executed to successfully execute the overall task further complicate the planning and execution. Classical work planning methodologies consider only feasibility without considering the physical limitations of the actual robot and are therefore difficult to apply to actual situations where uncertainty exists. Furthermore, uncertainty related challenges also emerge from sensors. For example, with robotic systems, techniques such as Computer Vision, while pivotal in parsing the semantic understanding of environments, cannot deliver robust information for contact-aware sensing needed to fully close the loop on intelligent robot assembly. A major concern arises from the multimodal inputs that robots must rely on to observe their environment. With various sensor modalities feeding information, there is an inherent uncertainty in the provided data because not all modalities carry meaningful information at the same time during the task.

The challenges do not end with sensor uncertainty. Robotic assembly tasks are implicitly long-horizon in nature. This means that robots need to plan, execute, and connect a series of relevant actions over an extended period of time to achieve the desired global outcome. Conventional approaches such as behavioral cloning and other learning from demonstration (LfD) approaches have fallen short in these scenarios. Robust solutions for robotic assembly tasks that address the aforementioned challenges are still desired.

### SUMMARY

The field of robotic manipulation is undergoing a paradigm shift with the recent developments in Artificial Intelligence (AI) based techniques. Some embodiments are based on the realization that the next generation of robots are required to perform complex manipulation tasks much more efficiently, thereby reducing the costs associated in commissioning of these systems for automation. Some example embodiments are directed towards learning, estimation, control and optimization approaches for efficiently performing complex assembly tasks by exploiting contacts during manipulation via physics-based modeling augmented with data-driven learning. Some example embodiments provide systems and methods for enabling reliable operation of assembly tasks by a synergistic combination of advanced sensing, learning and optimization techniques.

Various types of robotic manipulators are developed for performing a variety of operations such as material handling, transportation, welding, assembly, and the like. The assembly operation may correspond to connecting, coupling, or positioning a plurality of parts in a particular configuration. The robotic manipulators include various components that are designed to aid the robotic manipulators in interacting with an environment and performing the operations. Such components may include robotic arms, actuators, and end-effectors.

It is an object of some embodiments to provide a system and a method for controlling a robotic manipulator according to a task. Examples of the task include an assembly operation, such as furniture assembly, assembly of cars, or microchips. Additionally, or alternatively, it is an object of some embodiments to provide such a system and the method that can control the robotic manipulator with motion planning over an extended prediction horizon.

Some embodiments are based on recognizing that motion planning over the extended prediction horizon can benefit from hierarchical planning when the actions are grouped by skills. This allows performing a task using a hierarchical control, where each task is broken down into a hierarchy of skills and actions of the skills. Such a hierarchical control can include two parts. First, a skill is selected, and, next, an action or a sequence of actions of the skill is used to control the robotic manipulator.

However, to train such a hierarchical control policy with machine learning for the contact-rich environment of robotic manipulation is challenging. For example, for some applications, the contact-rich nature of robotic assembly problem usually relies on multi-modal feedback signals including signals of one or more visuo-tactile sensors attached to the end effector of the robotic manipulator, video frames of a camera observing the state of execution of the task, and proprioceptive measurements of encoders measuring the state of the actuators of the robotic manipulator. However, some embodiments are based on the realization that the multimodal sensor inputs in the horizon differ drastically between the training and execution stages due to the difference in task configurations. These complexities, when put on top of the extended horizon motion planning with hierarchical control, make learning the relationships between the sequence of skills and the corresponding sequence of action challenging.

Some embodiments are based on recognizing that these complexities can be alleviated with a neural network having a self-attention module with a hierarchically conditioned output to produce a skill of the robotic manipulator and an action conditioned on the skill. While only the action is used for controlling the robotic manipulator, outputting both the skills and the action creates a learnable temporal dependency not only among the actions but also among the skills. According to some embodiments, when combined with the conditional output of actions, the self-attention module with a hierarchically conditioned output creates a single framework for the hierarchical control allowing to learn both the spatial and temporal relationships of the hierarchy. This framework is amenable to training and simplifies the computational requirements during the control of the robotic manipulator.

Some example embodiments are particularly directed towards improving the quality of Learning from Imperfect Demonstration (LfID) for long-horizon robotic assembly tasks. In this regard, some embodiments define the quality in terms of accuracy of assembly task and efficiency of the assembly task. Additionally, some embodiments also consider an average reward metric to evaluate the quality of the goal-reaching quality in the learned policy. The accuracy of assembly task may be expressed as an average success rate which indicates success in different assembly tasks or sub-tasks while the efficiency may be expressed as average steps defined as a ratio of number of time steps in a task and total number of tasks.

In order to achieve the aforementioned advantages and objectives, some example embodiments provide systems, methods, and computer programs for controlling a robotic manipulator according to a task.

Accordingly, some example embodiments provide a feedback controller for controlling a robotic manipulator according to a task. The robotic manipulator includes one or more actuators operatively coupled to one or more joints of the robotic manipulator for moving an end effector. The feedback controller includes a circuitry configured to accept a feedback signal including a sequence of multi-modal observations of a state of execution of the task. The multi-modal observations include measurements of one or more visuo-tactile sensors attached to the end effector video frames of a camera observing the state of execution of the task, and proprioceptive measurements of one or more actuators. The circuitry processes the multi-modal observations with a neural network having a self-attention module with a hierarchically conditioned output to produce a skill of the robotic manipulator and an action conditioned on the skill. Each skill defines a combination of actions, and the neural network is trained in a supervised manner with demonstration data to produce a sequence of skills and a corresponding sequence of actions for the actuators of the robotic manipulator to perform the task. The circuitry determines one or more control commands for the one or more actuators based on the produced action and submits the one or more control commands to the one or more actuators causing a change of the state of execution of the task.

In yet another example embodiment, a computer-implemented method for controlling a robotic manipulator according to a task is provided. The robotic manipulator includes one or more actuators operatively coupled to one or more joints of the robotic manipulator for moving an end effector. The method comprises accepting a feedback signal including a sequence of multi-modal observations of a state of execution of the task. The multi-modal observations include measurements of one or more visuo-tactile sensors attached to the end effector video frames of a camera observing the state of execution of the task, and proprioceptive measurements of one or more actuators. The multi-modal observations are processed with a neural network having a self-attention module with a hierarchically conditioned output to produce a skill of the robotic manipulator and an action conditioned on the skill. Each skill defines a combination of actions, and the neural network is trained in a supervised manner with demonstration data to produce a sequence of skills and a corresponding sequence of actions for the actuators of the robotic manipulator to perform the task. The method further comprises determining one or more control commands for the one or more actuators based on the produced action and submitting the one or more control commands to the one or more actuators causing a change of the state of execution of the task.

In yet some other example embodiments, a non-transitory computer readable medium having stored thereon computer executable instructions for performing a method for controlling a robotic manipulator according to a task is provided. The robotic manipulator includes one or more actuators operatively coupled to one or more joints of the robotic manipulator for moving an end effector. The method comprises accepting a feedback signal including a sequence of multi-modal observations of a state of execution of the task. The multi-modal observations include measurements of one or more visuo-tactile sensors attached to the end effector video frames of a camera observing the state of execution of the task, and proprioceptive measurements of one or more actuators. The multi-modal observations are processed with a neural network having a self-attention module with a hierarchically conditioned output to produce a skill of the robotic manipulator and an action conditioned on the skill. Each skill defines a combination of actions, and the neural network is trained in a supervised manner with demonstration data to produce a sequence of skills and a corresponding sequence of actions for the actuators of the robotic manipulator to perform the task. The method further comprises determining one or more control commands for the one or more actuators based on the produced action and submitting the one or more control commands to the one or more actuators causing a change of the state of execution of the task.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a block diagram of a robotic assembly, according to some example embodiments;

FIG. 1B illustrates a paradigm of motion planning over an extended prediction horizon with hierarchical planning, according to some example embodiments;

FIG. 1C illustrates a method for controlling a robotic manipulator according to a task, in accordance with some example embodiments;

FIG. 1D illustrates schematics of a robotic manipulator for object assembly, in accordance with some example embodiments;

FIG. 2A illustrates schematics of a robotic assembly controlled according to a task, in accordance with some example embodiments;

FIG. 2B illustrates the structure of a tactile ensemble skill transformer at inference, according to some embodiments;

FIG. 3A illustrates schematics of a robot arm control system at inference, according to some embodiments;

FIG. 3B illustrates a block diagram of one layer of an attention-based transformer encoder, according to some embodiments;

FIG. 4 illustrates an inference loop of a robot arm in an assembly environment, according to some embodiments;

FIG. 5A illustrates a training pipeline of a Tactile Ensemble Skill Transfer (TEST) module of a robot control system, according to some embodiments;

FIG. 5B illustrates the structure of a tactile ensemble skill transformer at training, according to some embodiments;

FIG. 6 illustrates some steps of a learning procedure of a Skill Transition Model (STM), given the demonstration data, according to some embodiments;

FIG. 7 illustrates some steps of a learning procedure of a Tactile Ensemble Policy Optimization (TEPO), given the demonstration data, according to some embodiments;

FIGS. 8A and 8B jointly illustrate an algorithm for the training pipeline of a tactile ensemble skill transformer, according to some embodiments; and

FIG. 9 illustrates some components of feedback controller for controlling a robotic manipulator according to a task, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Robotic assembly is regarded as one of the most complex problems within the field of robotic manipulations, given its contact-rich and long-horizon nature. Also, the contextual purpose of the objects and the associated sub-tasks that must be executed to succeed the overall task further complicate the planning and execution. Particularly, such tasks often face uncertainty related challenges from sensory inputs. A major concern arises from the multimodal inputs that robots must rely on to observe their environment. With various sensor modalities feeding information, there is an inherent uncertainty in the provided data because not all modalities carry meaningful information at the same time during the task. Also, robotic assembly tasks are implicitly long-horizon in nature and require robust planning and execution for actions over an extended period of time to achieve a desired outcome. A natural pipeline of such assembly tasks requires learning several candidate skills such as pick, reach, insert, adjust, and thread.

Some embodiments provide an offline reinforcement learning (RL) approach that incorporates tactile feedback in the control loop. Some embodiments provide a framework whose core design is to learn a skill transition model for high-level planning, along with a set of adaptive intra-skill goal-reaching policies. Such design aims to solve the robotic assembly problem in a more generalizable way, facilitating seamless chaining of skills for this long-horizon task. In this regard, some embodiments first sample demonstrations from a set of heuristic policies and trajectories consisting of a set of randomized sub-skill segments, enabling the acquisition of rich robot trajectories that capture skill stages, robot states, visual indicators, and crucially, tactile signals. Leveraging these trajectories, the offline RL method discerns skill termination conditions and coordinates skill transitions. The proposed framework finds applications in the in-distribution object assemblies and is adaptable to unseen object configurations while ensuring robustness against visual disturbances.

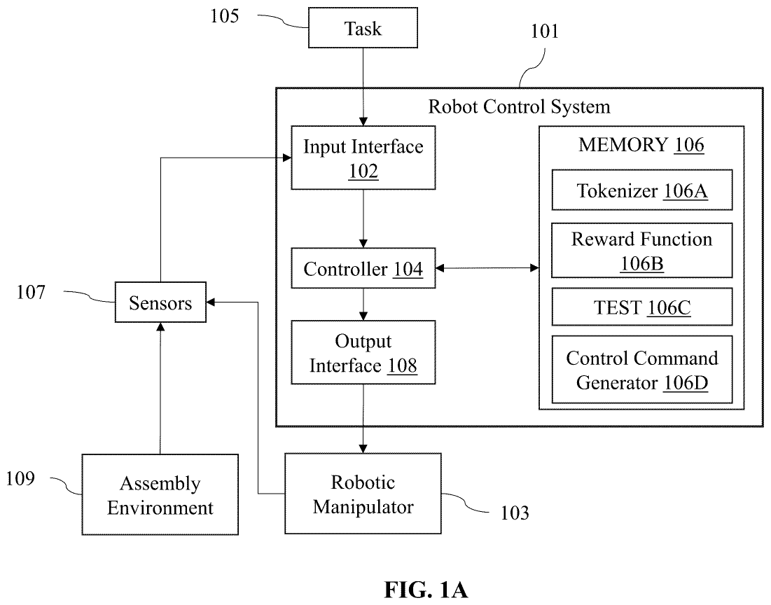

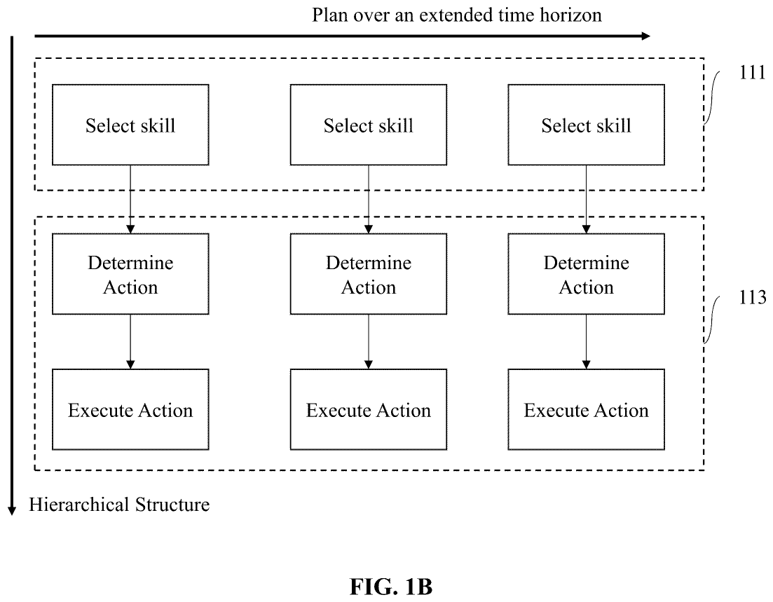

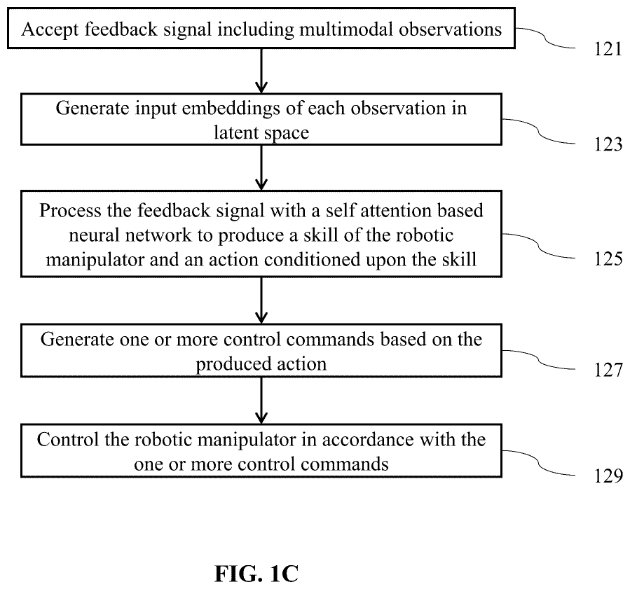

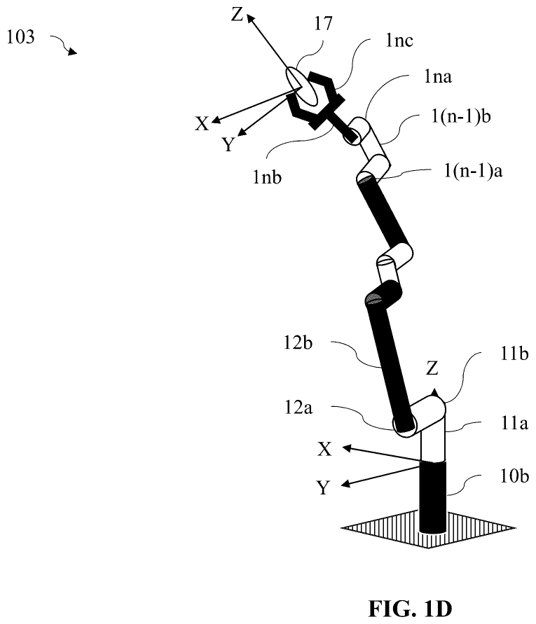

FIG. 1A illustrates a block diagram of a robotic assembly, according to some example embodiments. The robotic assembly comprises a robot control system 101 for controlling a robotic manipulator 103 according to a given task 105. According to some embodiments, the task 105 may be an object assembling task such as furniture assembly and may be sub-divided into a plurality of sub-tasks, each achievable or realizable through a series of actions. The task 105 may correspond to connecting, coupling, or positioning a plurality of parts in a particular configuration. According to some embodiments, the task modelling considers each task as a combination of hierarchical skills and actions of those skills. The task 105 may be received (accepted) by the robot control system 101 via an input interface 102.

One or more feedback signals from a plurality of sensors 107 may be received by the robot control system 101 via the interface 102. According to some embodiments, the sensors 107 may comprise sensors for capturing observation data for the robotic manipulator 103 and/or its environment 109. In this regard, the observation data may comprise multi-modal observations pertaining to the manipulator 103 and/or the assembly environment 109. According to some embodiments, the multi-modal observations include tactile, visual, and proprioceptive observations of the manipulator 103 and the assembly environment 109. For example, the multi-modal observations include measurements of one or more visuo-tactile sensors attached to the end effector of the manipulator 103 for tracking the motion of markers on the sensor, video frames of a camera observing the state of execution of the task 105 for the pose estimation of the object, and proprioceptive measurements of one or more actuators of the manipulator 103. The robot control system 101 operates in a feedback loop to generate a hierarchical output with output actions conditioned upon skills required to perform the task 105. That is, at each instance of time, the input observations are processed to predict an action conditioned upon a skill of the robotic manipulator 103. The action is translated into one or more control commands and transmitted to the robotic manipulator 103 to perform contact rich manipulation with real world objects to execute the assembly task. Each skill defines a combination of actions for the manipulator. Upon execution of the commands, the state of the robotic manipulator 103 and the objects in the assembly environment 109 changes. Accordingly, the sensors 107 recapture the multimodal observations and the processing is repeated until all the sub-tasks of the assembly task are executed. Thus, the input bundle is used to predict the target pose as the action for a current timestep. At each step, the inputs are aggregated to predict the state at the current timestep.

The robot control system 101 may be realized through suitable processing, communicative, and computational circuitry comprising the input interface 102, a controller 104, a memory 106, and an output interface 108. The controller 104 processes the input data received via the input interface 102 by invoking various modules stored in the memory 106. In this regard, the memory 106 may be configured to store a tokenizer module 106A, a reward function 106B, a Tactile Ensemble Skill Transfer (TEST) module 106C, and a control command generator 106D. The tokenizer 106A encodes each of the multimodal observations into an embedding of that observation in a latent space. For example, the tokenizer 106A generates a proprioception embedding input, a visual signal embedding input, a contact information embedding input, a demonstrated action embedding input, and the like from the multi-modal observations.

According to some embodiments, the reward function 106B is goal conditioned, labeled by the sequential information from demonstrated trajectories, and is utilized by the controller 104 to evaluate the quality of the goal-reaching quality in the learned policy defined by the TEST module 106C. According to some example embodiments, the reward function 106B may be a hyperparameter of a decision transformer of the TEST module 106C. The reward function 106B may be expressed as a budget of the cumulative of a negative distance to a goal and an indication function of reaching the goal.

The Tactile Ensemble Skill Transfer (TEST) module 106C defines a framework using a reinforcement learning (RL) approach that incorporates tactile feedback in the control loop. It is realized with a trained neural network having a self-attention module with a hierarchically conditioned output to produce a skill of the robotic manipulator and an action conditioned on the skill. Thus, the TEST module 106C combines self-attention mechanisms with hierarchical conditioning to produce structured outputs. The key components of the model architecture include a self-attention mechanism, hierarchical conditioning, and output generation. The self-attention mechanism serves as the core component of the network that allows it to weigh the importance of different elements in the input sequence based on their relationships. Self-attention mechanisms calculate attention scores between all pairs of elements in the input sequence and use these scores to compute weighted sums, which are then passed through feedforward layers to produce output representations. Hierarchical Conditioning uses hierarchical information to condition the output generation process. Hierarchical conditioning can be achieved in various ways, such as by incorporating hierarchical information into the input embeddings or by using hierarchical attention mechanisms to attend to different levels of abstraction in the input sequence. The output generation process takes the output representations produced by the self-attention mechanism and hierarchically conditioned input and generates structured outputs based on the task at hand. The model may be trained using a suitable objective function that measures the discrepancy between the predicted outputs and the ground truth outputs (demonstration data). This could be a mean squared error for regression tasks, or it could be a task-specific loss function designed to optimize performance on a particular task.

TEST's core design is to learn a skill transition model for high-level planning, along with a set of adaptive intra-skill goal-reaching policies. The robotic assembly task is formulated as a skill-based RL problem over Goal-conditioned Partially Observable Markov Decision Process (GC-POMDP) that capitalizes on multimodal sensor inputs instead of the fully observable states. The approach followed by TEST module 106C seamlessly integrates the strengths of ensemble learning with tactile feedback and skill-conditioned policy learning.

Assembly tasks require the same set of robot skills such as but not limited to picking, insertion, and threading. A common way of assembling these skills in a working robotic platform is by Learning from Demonstration (LfD). LfD allows robots to learn policy from humans or heuristic demonstrations. In the real-world application, however, LfD is challenging due to its long task horizon and the multimodal nature of the observations.

FIG. 1B illustrates a paradigm of motion planning over an extended prediction horizon with hierarchical planning when the actions are grouped by skills, according to some embodiments. The planning comprises selecting skills 111 over an extended time horizon while determining and executing actions 113 in a hierarchical structure. In such a framework, each task is broken down into a hierarchy of skills 111 and actions 113 of the skills. First, a skill is selected, and, next, an action or a sequence of actions of the skill is used to control the robotic manipulator. An action executed at a current time step is used for predicting/selecting a next skill using which the next action to be performed is determined and executed until the goal associated with the overall task is achieved.

The contact-rich nature of robotic assembly problem relies on multi-modal feedback signals including signals of one or more visuo-tactile sensors attached to the end effector of the robotic manipulator, video frames of a camera observing the state of execution of the task, and proprioceptive measurements of encoders measuring the state of the actuators of the robotic manipulator. However, some embodiments are based on the realization that the multimodal sensor inputs in the horizon differ drastically between the training and execution stages due to the difference in task configurations. These complexities, when put on top of the extended horizon motion planning with hierarchical control, make learning the relationships between the sequence of skills and the corresponding sequence of action challenging.

Some embodiments are based on recognizing that these complexities can be alleviated with a neural network having a self-attention module with a hierarchically conditioned output to produce a skill of the robotic manipulator and an action conditioned on the skill. While only the action is used for controlling the robotic manipulator, outputting both the skills and the action creates a learnable temporal dependency not only among the actions but also among the skills. According to some embodiments, when combined with the conditional output of actions, the self-attention module with a hierarchically conditioned output creates a single framework for the hierarchical control allowing to learn both the spatial and temporal relationships of the hierarchy.

FIG. 1C illustrates a method for controlling the robotic manipulator 103 of FIG. 1A according to the task 105, in accordance with some example embodiments. The feedback signal including multimodal observations is received/accepted 121 by the robotic controller 104 at each instance of time. According to some embodiments, the feedback signal may be provided in a time-continuous manner or discrete manner. Alternately, in some embodiments, the feedback signal may be provided on demand, for example, after an action has been executed. The controller 104 invokes the tokenizer module 106A to generate 123 input embeddings of each observation in a latent space. In this regard, the tokenizer module 106A may be any suitable encoder that encodes the observations in state space into their embeddings in the latent space. The embeddings of the observations together with a reward function 106B are processed 125 at each instance of time with a neural network of the TEST module 106C. The neural network has a self-attention module trained to produce a skill of the robotic manipulator and ultimately an action conditioned upon the skill. The controller 104 invokes the control command generator 106D to generate 127 one or more control commands based on the produced action at step 125. In this regard, the control command generator 106D may reference a stored table that maps actions with corresponding control commands. According to some embodiments, the control command generator 106D may dynamically generate the control commands for executing the produced action based on the state information of the robotic manipulator 103 and the objects in the assembly environment 109. The controller 104 outputs the generated control commands to one or more actuators of the robotic manipulator 103 to control 129 the robotic manipulator 103, for example by causing a change of the state of execution of the task. The steps 121-129 are repeated iteratively for each sub-task of the task 105.

FIG. 1D illustrates schematics of the robotic manipulator 103 for object assembly, in accordance with some example embodiments. The manipulator 103 may be an n degree-of-freedom (DOF) open-chain manipulator. The manipulator 103 comprises a base 10b, multiple joints, multiple links and an end-effector 10nc where each joint may typically move in one or more directions. The manipulator 103 may be used to perform one or more tasks such as manipulating one or more payloads such as an object 17. The specific task may be defined in terms of parameters including, e.g., an initial position and velocity of the object 17, a final position and velocity of the object 17, acceleration and velocity constraints on the object 17, time to accomplish the task, and the like. The manipulator 101 may be electronically coupled to a control system such as the robot control system 101 of FIG. 1A that provides control inputs/commands to execute the task. An interface may be utilized to receive or collect one or more tasks. According to some embodiments, the base 10b may be mountable on a surface such as the floor or a movable platform. The other end of the base 10b may be mechanically coupled with a first-axis link 11b through a first-axis joint 11a. The first-axis link 11b is coupled with a second-axis joint 12a, which is connected to a second-axis link 12b. This coupling and connection patterns are repeated until reaching the end-effector Inc, which is attached on a last-axis link 1nb. The last-axis link 1nb is coupled with a previous link 1(n−1)b through a last-axis joint 1na. According to some embodiments, one or more components of the manipulator 103 may be modeled in any suitable manner such as in terms of mathematical equations and a corresponding model of the components may be accessible to the control system of the manipulator 103. Each such model may describe interaction between various variables pertaining to the corresponding component such as control input variables, state variables (for example position, orientation, heading etc.).

In some embodiments, a joint of the manipulator 103 may be of any suitable type including but not limited to: revolute, prismatic, helical etc. The movements of the joints of the manipulator 103 may be controlled by one or more actuators coupled to the joints such that the manipulator 103 can be moved in accordance with one or more control inputs to effectuate manipulation of the payload 17 along any dimension.

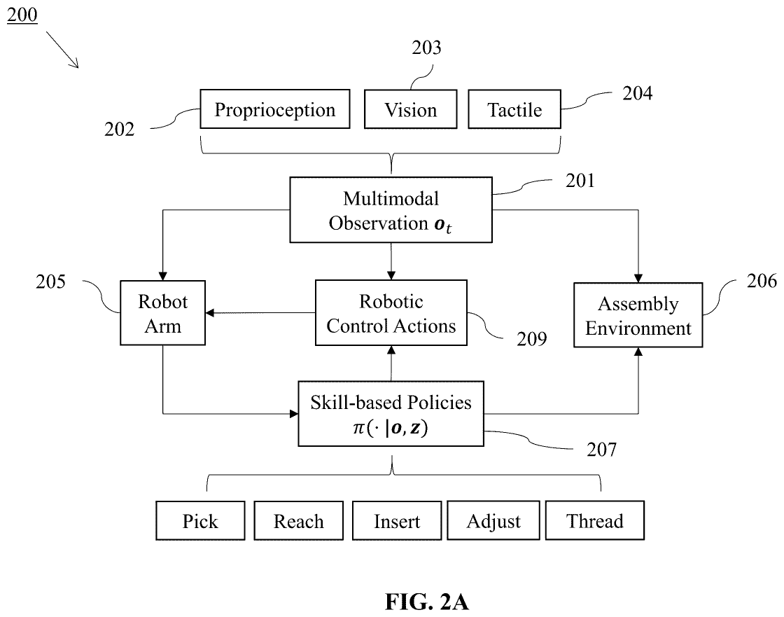

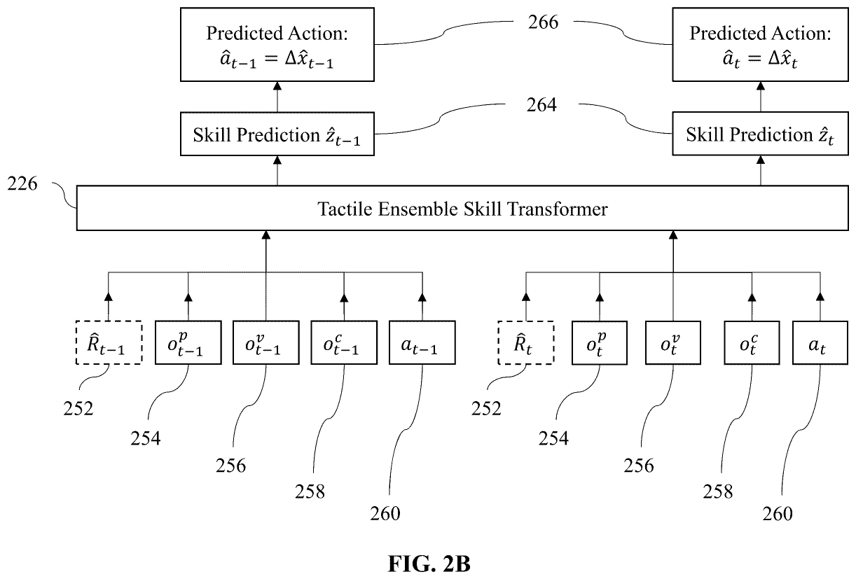

FIG. 2A illustrates schematics of a robotic assembly 200 controlled according to a task, in accordance with some example embodiments. Multimodal observations oₜ 201 may include proprioception inputs 202, visual inputs 203, and tactile inputs 204 corresponding to the robot arm (robotic manipulator) 205 and the assembly environment 206. A library of skills required for performing the task may be stored in the memory. The skills may include without limitation skills such as pick, reach, insert, adjust, thread and similar skills that are desired for performing assembly tasks.

Referring to FIGS. 1A and 2A, the objective of TEST module 106C is to improve the quality of Learning from Imperfect Demonstration (LfID) for long-horizon robotic assembly tasks. Assume N skill primitives and denoting a skill set as

$${\{ {z}^{( i )} \}}_{i = 1}^{N} ,$$

a skill-labeled offline dataset may be given by some heuristic behavior policy π₀⁽ⁱ⁾, where (i) refers to the skill index of z. The TEST module 106C predicts robotic control actions 209 in view of the multimodal observation 201 and in accordance with the skill-based policies 207.

In general, the objective of the assembly task includes two parts: accuracy and efficiency. For the accuracy of assembly, some embodiments evaluate the accuracy via the Average Success Rate (ASR), i.e.

$$ASR = \frac{\#taskssucceeded}{\#alltasks} ,$$

which indicates success in different assembly tasks or sub-tasks. For the efficiency of assembly, some embodiments evaluate the Average Steps (AS), where

$$AS = \frac{\#timesteps}{\#alltasks} .$$

To better evaluate the quality of the goal-reaching quality in the learned policy, some embodiments also consider the Average Reward (AR) as one of the metrics.

The assembly problem may be formulated in the Goal-conditioned Partially Observable Markov Decision Process (GC-POMDP). A GC-POMDP may be defined as a tuple ( [symbol] , [symbol] , [symbol] , [symbol] , [symbol] , [symbol] ,Ω), where [symbol] is the state space. Here the states may be defined as the six-dimensional (6D) pose of the objects of interest. [symbol] is the action space that indicates the target pose and movement of the end-effector. [symbol] is a finite set of observations, and the robotic assembly system, in fact, gives multimodal observations o=[o^{p}, o^{v}, o^{c}], where o^{p} is the proprioceptive observation of the manipulator, o^{v} represents the vision observation from an external camera, and o^{c} refers to the contact-aware observation given by the tactile sensors. [symbol] is the state transition probability function. [symbol] is the goal space in the 6D pose of the objects to be assembled together, G⊂S. [symbol] : [symbol] × [symbol] → [symbol] is the reward function. The reward function is induced by the target goal g∈G. Ω:S×A→0 is the observation function, which maps a state-action pair to an observation. It captures the probability of observing o after taking action α and ending up in state s′, i.e., Ω(o|s′,α). The objective in GC-POMDP is to find a policy that maximizes the expected cumulative reward

$${max}_{π} {𝔼}_{π} [ {\sum }_{t = 0}^{T} {γ}^{t} {r}_{t} \vert {O}_{t} ]$$

over time.

Further, the robotic assembly task is modeled by adopting the skill learning formulation in the above GC-POMDP. The skill-based RL problem is represented as a tuple (I_{z},π_{z},β_{z}) associated with certain skill z. I_{z} is the initial set of states of skill z, π_{z}=π(·|o,z) is a goal-conditioned skill-conditioned policy, and β_{z}: [symbol] →[0,1] is a termination function of the skill z.

Firstly, the skill primitives required to finish the assembly tasks during testing is the superset of skills demonstrated in the training environments, i.e. zₜₑₛₜ ⊂zₜᵣₐᵢₙ. Secondly, it may be considered that whenever the end-effector of the robotic manipulator reaches the goal of skill z, the manipulator always has smooth transition to the next candidate skill in the assembly tasks, i.e. ∃z′, ∀G_{z}={s|β_{z}(s)=1}, G_{z}⊂I_{z′}.

FIG. 2B illustrates the structure of a tactile ensemble skill transformer 226 at inference, according to some embodiments. The transformer 226 is a part of the TEST module 106C. The input to the transformer 226 at a time step comprises tokens of the multimodal observations (o) 254-260 at that timestep along with a token of a reward budget (\hat{R}) 252 defined according to the reward function of FIG. 1A. The multimodal observations are given by o=[o^{p}, o^{v}, o^{c}], where o^{p} is the proprioceptive observation of the manipulator, o^{v} represents the vision observation from an external camera, and o^{c} refers to the contact-aware observation given by the tactile sensors. At each instance of observation time, the transformer 226 performs skill prediction 264 (\hat{z}ₜ) using a Skill Transition Model (high-level planner). A Tactile Ensemble Policy Optimization sub module (low level planner) of the transformer 226 outputs an action 266 (\hat{α}ₜ) conditioned upon the predicted skill. According to some embodiments, the target pose of the end effector may be output as the action for a current timestep. According to some embodiments, the reward budget 252 may be optional at inference time of the transformer 226.

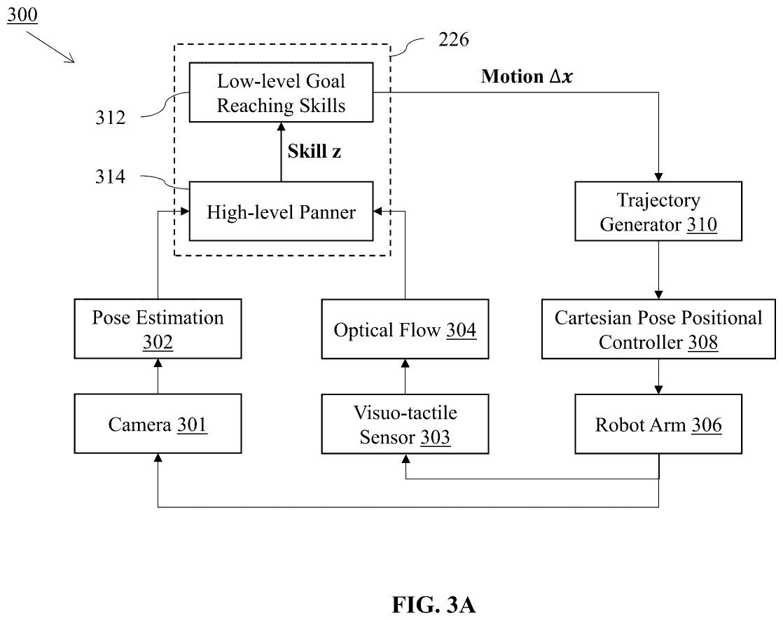

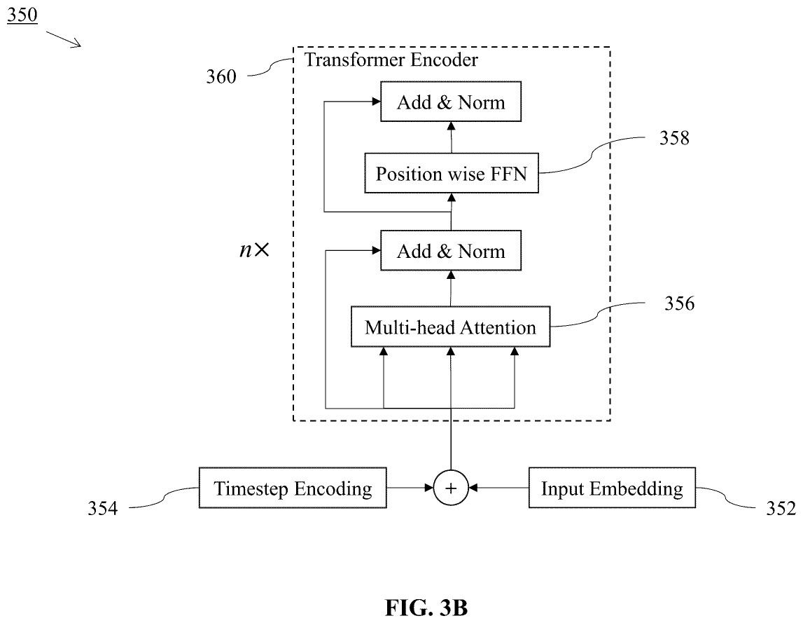

FIG. 3A illustrates schematics of a robot arm control system 300 at inference, according to some embodiments. The robot control system performs control of the robot arm 306 in an iterative manner where at each iteration the sensory signals are obtained from a camera 301 and a visual tactile sensor 303. According to some embodiments, instead of directly using the camera vision inputs, pose estimation 302 of each part/object is performed. However, this post estimation may be erroneous. For example, the camera 301 may have a blurred optical input path or the image may be occluded in a current perspective. Accordingly, the pose estimation output 302 is supplemented with the proprioceptive state of the robot arm 306. Also, the contact information of the robot arm 306 with the robot's environment obtained via the optical flow 304 to track the how the context surface actually interacts with the objects of interest, may also be used to supplement the pose estimation output 302.

The cumulative input of the pose estimation output 302 and the contact information from the optical flow 304 is fed to the tactile ensemble skill transformer 226. A high-level planner 314 implemented as a skill transition model (STM) predicts the skill z based on the cumulative input. The predicted skill z is then used by a low-level goal reaching skill module 312 of the transformer 226, which is realized as a tactile ensemble policy optimization (TEPO) submodule, to output motion data Ax which is an action conditioned upon the predicted skill. The motion data is output to a trajectory generator 310 that generates a trajectory of poses and states of the robot arm 306. The trajectory is utilized by a cartesian pose positional controller 308 to generate control commands (voltages and currents) to control one or more actuators of the robot arm to execute the action.

FIG. 3B illustrates a block diagram of one layer 350 of an attention-based transformer encoder 360, according to some embodiments. According to some embodiments, there may be any suitable number (n) of such layers of the transformer encoder. The attention-based transformer encoder 360 is implemented as a neural network system realized through computer programs on one or more computers in one or more locations.

The transformer encoder 360 receives an input sequence comprising input embeddings 352 and timestep encodings 354 from an embedding layer and processes the input sequence to transduce the input sequence into an output sequence. The input sequence has a respective network input at each of multiple input positions in an input order and the output sequence has a respective network output at each of multiple output positions in an output order. That is, the input sequence has multiple inputs arranged according to an input order and the output sequence has multiple outputs arranged according to an output order. The transformer encoder 360 is realized an attention-based sequence transduction neural network.

The encoder 360 is configured to receive the input sequence and generate a respective encoded representation of each of the network inputs in the input sequence. Generally, an encoded representation is a vector or other ordered collection of numeric values.

The embedding layer is configured to, for each network input in the input sequence, map the network input to a numeric representation of the network input in an embedding space, e.g., into a vector in the embedding space. The embedding layer then provides the numeric representations of the network inputs to the encoder subnetwork 360. According to some embodiments, the embedding layer is configured to map each network input to an embedded representation of the network input and then combine, e.g., sum or average, the embedded representation of the network input with a positional embedding of the input position of the network input in the input order to generate a combined embedded representation of the network input. That is, each position in the input sequence has a corresponding embedding and for each network input the embedding layer combines the embedded representation of the network input with the embedding of the network input's position in the input sequence. Such positional embeddings can enable the model to make full use of the order of the input sequence without relying on recurrence or convolutions. In some cases, the positional embeddings are learned. As used in this specification, the term “learned” means that an operation or a value has been adjusted during the training of the sequence transduction neural network 360.

Each encoder subnetwork 360 includes an encoder self-attention sub-layer 356. configured to receive the subnetwork input for each of the plurality of input positions and, for each particular input position in the input order, apply an attention mechanism over the encoder subnetwork inputs at the input positions using one or more queries derived from the encoder subnetwork input at the particular input position to generate a respective output for the particular input position. In some cases, the attention mechanism is a multi-head attention mechanism. In some implementations, each of the encoder subnetworks 360 also includes a residual connection layer that combines the outputs of the encoder self-attention sub-layer with the inputs to the encoder self-attention sub-layer to generate an encoder self-attention residual output and a layer normalization layer that applies layer normalization to the encoder self-attention residual output. These two layers are collectively referred to as an “Add & Norm” operation in FIG. 3B.

According to some embodiments in some or all instances, the encoder subnetworks 360 may also include a position-wise feed-forward layer 358 that is configured to operate on each position in the input sequence separately. In particular, for each input position, the feed-forward layer 358 is configured to receive an input at the input position and apply a sequence of transformations to the input at the input position to generate an output for the input position. For example, the sequence of transformations can include two or more learned linear transformations each separated by an activation function, e.g., a non-linear elementwise activation function, e.g., a ReLU activation function, which can allow for faster and more effective training on large and complex datasets. The inputs received by the position-wise feed-forward layer 358 can be the outputs of the layer normalization layer when the residual and layer normalization layers are included or the outputs of the encoder self-attention sub-layer 356 when the residual and layer normalization layers are not included. The transformations applied by the layer 358 will generally be the same for each input position (but different feed-forward layers in different subnetworks will apply different transformations).

In cases where an encoder subnetwork 360 includes a position-wise feed-forward layer 358, the encoder subnetwork can also include a residual connection layer that combines the outputs of the position-wise feed-forward layer with the inputs to the position-wise feed-forward layer to generate an encoder position-wise residual output and a layer normalization layer that applies layer normalization to the encoder position-wise residual output. These two layers are also collectively referred to as an “Add & Norm” operation in FIG. 3B. The outputs of this layer normalization layer can then be used as the outputs of the transformer encoder subnetwork 360.

Generally, an attention mechanism maps a query and a set of key-value pairs to an output, where the query, keys, and values are all vectors. The output is computed as a weighted sum of the values, where the weight assigned to each value is computed by a compatibility function of the query with the corresponding key. Referring to FIG. 3B, each attention sub-layer 356 applies a scaled dot-product attention mechanism. In scaled dot-product attention, for a given query, the attention sub-layer computes the dot products of the query with all of the keys, divides each of the dot products by a scaling factor, e.g., by the square root of the dimensions of the queries and keys, and then applies a softmax function over the scaled dot products to obtain the weights on the values. The attention sub-layer then computes a weighted sum of the values in accordance with these weights. Thus, for scaled dot-product attention the compatibility function is the dot product, and the output of the compatibility function is further scaled by the scaling factor.

In operation, the attention sub-layer 356 computes the attention over a set of queries simultaneously. In particular, the attention sub-layer packs the queries into a matrix Q, packs the keys into a matrix K, and packs the values into a matrix V. To pack a set of vectors into a matrix, the attention sub-layer can generate a matrix that includes the vectors as the rows of the matrix. The attention sub-layer 356 then performs a matrix multiply (MatMul) between the matrix Q and the transpose of the matrix K to generate a matrix of compatibility function outputs. The attention sub-layer 356 then scales the compatibility function output matrix, i.e., by dividing each element of the matrix by the scaling factor. The attention sub-layer 356 then applies a softmax over the scaled output matrix to generate a matrix of weights and performs a matrix multiply (MatMul) between the weight matrix and the matrix V to generate an output matrix that includes the output of the attention mechanism for each of the values.

In some implementations, to allow the attention sub-layers 356 to jointly attend to information from different representation subspaces at different positions, the attention sub-layers employ multi-head attention. In particular, to implement multi-head attention, the attention sub-layer 356 applies h different attention mechanisms in parallel. In other words, the attention sub-layer includes h different attention layers, with each attention layer within the same attention sub-layer receiving the same original queries Q, original keys K, and original values V.

Each attention layer is configured to transform the original queries and keys, and values using learned linear transformations and then apply the attention mechanism to the transformed queries, keys, and values. Each attention layer will generally learn different transformations from each other attention layer in the same attention sub-layer. In particular, each attention layer 356 is configured to apply a learned query linear transformation to each original query to generate a layer-specific query for each original query, apply a learned key linear transformation to each original key to generate a layer-specific key for each original key, and apply a learned value linear transformation to each original value to generate a layer-specific values for each original value. The attention layer 356 then applies the attention mechanism described above using these layer-specific queries, keys, and values to generate initial outputs for the attention layer. The attention sub-layer 356 then combines the initial outputs of the attention layers to generate the final output of the attention sub-layer. The attention sub-layer 356 may concatenate (concat) the outputs of the attention layers and applies a learned linear transformation to the concatenated output to generate the output of the attention sub-layer.

In some cases, the learned transformations applied by the attention sub-layer 356 reduce the dimensionality of the original keys and values and, optionally, the queries. For example, when the dimensionality of the original keys, values, and queries is d and there are h attention layers in the sub-layer, the sub-layer may reduce the dimensionality of the original keys, values, and queries to d/h. This keeps the computation cost of the multi-head attention mechanism similar to what the cost would have been to perform the attention mechanism once with full dimensionality while at the same time increasing the representative capacity of the attention sub-layer.

In the attention sub-layer of the transformer encoder 360, all of the keys, values and queries come from the same place, in this case, the output of the previous subnetwork in the encoder 360, or, for the encoder self-attention sub-layer in first subnetwork, the embeddings of the inputs and each position in the encoder can attend to all positions in the input order. Thus, there is a respective key, value, and query for each position in the input order. For each particular input position in the input order, the encoder self-attention sub-layer is configured to apply an attention mechanism over the encoder subnetwork inputs at the input positions using one or more queries derived from the encoder subnetwork input at the particular input position to generate a respective output for the particular input position.

Since the encoder self-attention sub-layer 356 implements multi-head attention, each encoder self-attention layer in the encoder self-attention sub-layer is configured to: apply a learned query linear transformation to each encoder subnetwork input at each input position to generate a respective query for each input position, apply a learned key linear transformation to each encoder subnetwork input at each input position to generate a respective key for each input position, apply a learned value linear transformation to each encoder subnetwork input at each input position to generate a respective value for each input position, and then apply the attention mechanism (i.e., the scaled dot-product attention mechanism described above) using the queries, keys, and values to determine an initial encoder self-attention output for each input position. The sub-layer then combines the initial outputs of the attention layers as described above.

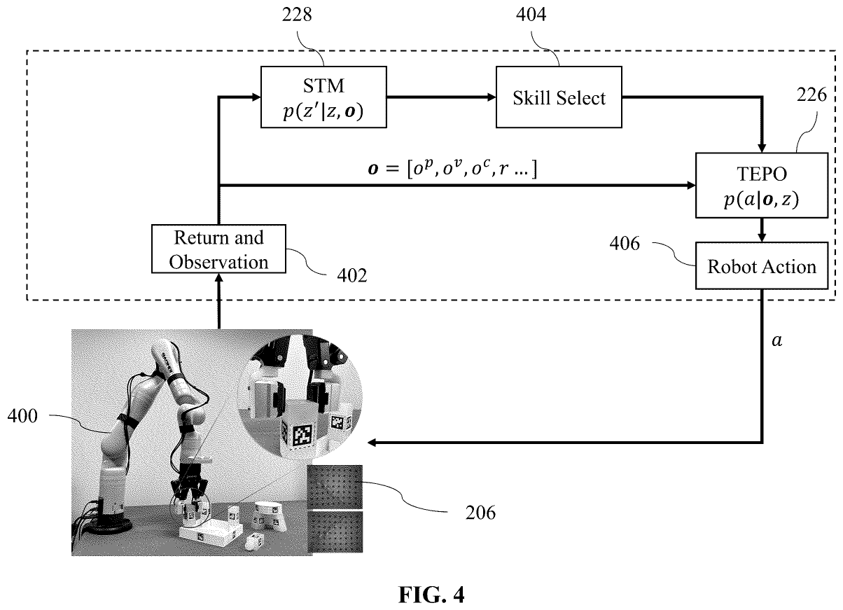

FIG. 4 illustrates an inference loop of a robot arm 400 in an assembly environment 206, according to some embodiments. The return and observations from the sensory inputs 402 are processed by the STM module 228 which predicts the skill 404 according to the observations 402. The STM module 228 performs the skill selection 404 as a classification based on a maximum likelihood. The TEPO module 226 takes the selected skill 404 and the observations o to determine a low-level robot action a 406 conditioned upon the skill. The action a is executed in the assembly environment 206 by the robot arm to achieve a sub-task of a robotic assembly task.

Aspects of the neural network having a self-attention module with a hierarchically conditioned output to produce a skill of the robotic manipulator and an action conditioned on the skill will now be described in detail. Some example embodiments train a hierarchical control policy with machine learning for the contact-rich environment of robotic manipulation. While only the action is used for controlling the robotic manipulator, outputting both the skills and the action creates a learnable temporal dependency not only among the actions but also among the skills. According to some embodiments, when combined with the conditional output of actions, the self-attention module with a hierarchically conditioned output creates a single framework for the hierarchical control allowing to learn both the spatial and temporal relationships of the hierarchy. This framework is amenable to training and simplifies the computational requirements during the control of the robotic manipulator.

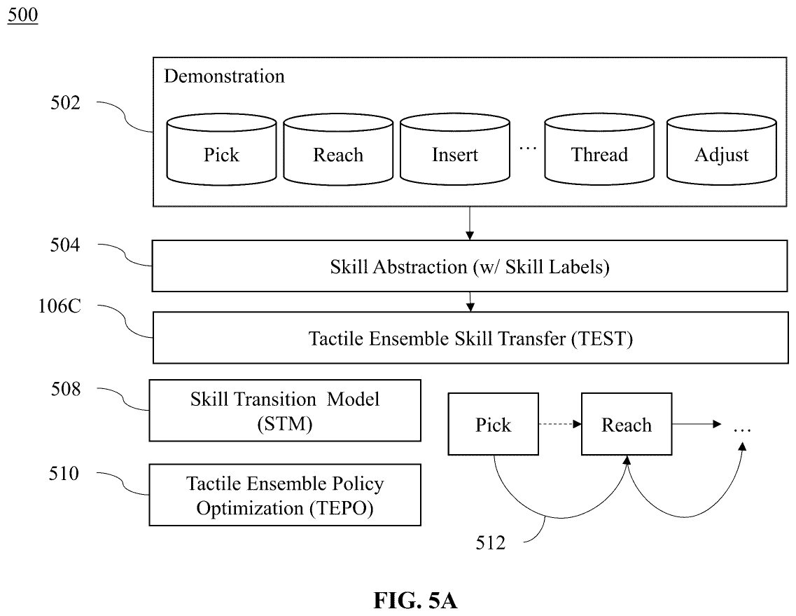

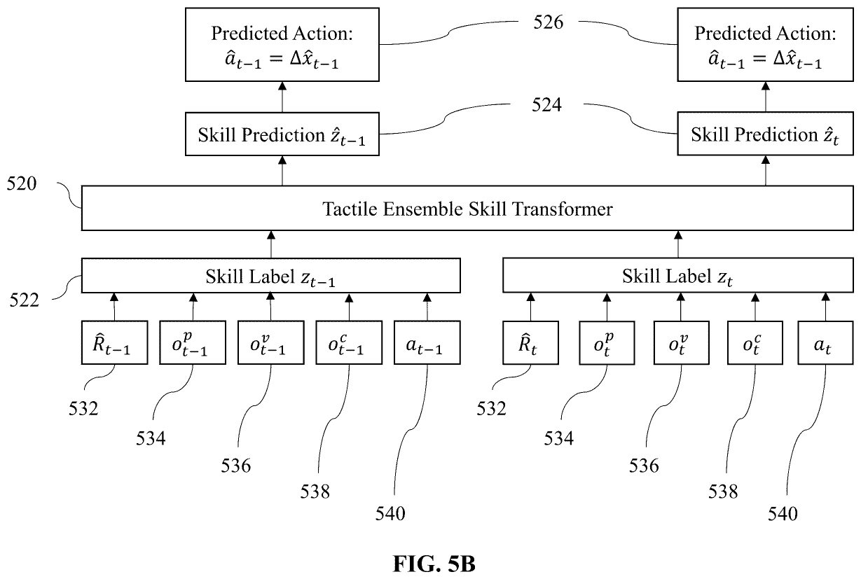

FIG. 5A illustrates a training pipeline 500 of the Tactile Ensemble Skill Transfer (TEST) module 106C of the robot control system of FIG. 1A, according to some embodiments. The TEST module 106C uses a Skill Transition Model (STM) 508, which learns the higher-level transition model p(z′|z, o). Then for each sub-skill, the intra-skill goal-reaching policies π(·|o,z) are learned via a Tactile Ensemble Policy Optimization (TEPO) submodule 510, which transforms offline RL into a sequential modeling problem with hindsight relabeling as data augmentation. Both STM 508 and TEPO 510 are implemented in an end-to-end Tactile Ensemble Skill Transformer.

FIG. 5B illustrates the structure of the tactile ensemble skill transformer 520 utilized by the TEST module 106C at training, according to some embodiments. FIG. 5B will be described with reference to FIG. 5A.

Referring to FIGS. 5A and 5B, some embodiments are directed towards learning the STM 508 as an inter-skill transition model that operates at a high level (similar to the high-level planner 314 of FIG. 3A), focusing on how different skills or sub-tasks can be chained together to achieve a complex, long-horizon task. An input trajectory with a skill horizon T may be expressed as τ={τᵢ}ᵢ₌₁^{T}. For each i∈[1,T]:

$${τ}_{i} = \{ {o}_{0} , {a}_{0} , {r}_{0} , {s}_{1} , … , {o}_{T - 1} , {a}_{T - 1} , {r}_{T - 1} ; g \} \qquad ( 1 )$$

where o is the observation data, α corresponds to the action, r corresponds to the reward function, g corresponds to the goal pose of the end effector, and s corresponds to the skill. The step reward is goal-conditioned, labeled by the sequential information from demonstrated trajectories:

$$r ( {s}_{t} , {g}_{t} ; z ) = {\underbrace{- {c}_{t}}}_{TimePenalty} {\underbrace{- d ( {s}_{t} , {g}_{t} ; z )}}_{DistancetoGoal} + {\underbrace{α ( {s}_{t} = {g}_{t} )}}_{ArrivalBonus} , \qquad ( 2 )$$

where gₜ={s_{t′}|max_{t′}t′<t, s.t. β_{z}(s_{t′})=1}, which is the last demonstration that satisfies the termination condition β. Following an autoregressive structure, every future z will depend on a context o of trajectory history,

$${o}_{t} = \{ {R}_{t - H + 1} , {o}_{t - H + 1} , {a}_{t - H + 1} , … {R}_{t} , {o}_{t} , {a}_{t} \} , \qquad ( 3 )$$

where Rₜ=_{Σt′≥t} r_{t′} is the summation of the future reward till the end of the episode, denoted as reward-to-go.

The inter-skill transition determines the sequence 512 in which different skills should be executed, ensuring smooth execution between consecutive trajectories of the skills. The STM 508 is formally defined as:

$${p}_{θ} ( {z}^{′} \vert z , o ) = Categorical ( {ℓ}_{θ} ( z , o ) ) , \qquad ( 4 )$$

where [symbol] _{θ}(·,·) is the output logits of decoder output followed by the Skill Transformer's encoder, as shown in the skill prediction block 524. It also considers potential dependencies between skills, ensuring that prerequisite tasks are completed before dependent ones.

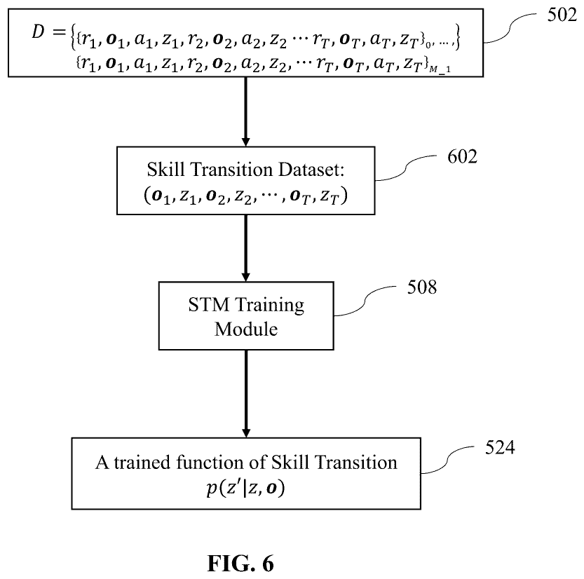

Referring to FIG. 5A and FIG. 6 which illustrates some steps of a learning procedure of the STM, in the demonstration collection phase 502, data is randomly sampled from the heuristic policy with a Finite State Machine (FSM). Then the skill transfer 504 is fitted based on the trajectory observation o and current skill z to obtain the skill transition dataset 602 given by:

(o₁,z₁,o₂,z₂, . . . ,o_{T},z_{T}).

The STM 508 aims to minimize the negative log-likelihood loss:

$${ℒ}_{STM} = {𝔼}_{τ ∼ {π}_{0}} {𝔼}_{z ∼ τ} [ - log {p}_{θ} ( {z}^{′} \vert z , o ) ] , \qquad ( 5 )$$

This gives a trained function 524 of skill transition (z′|z,o). By leveraging tactile feedback and ensemble learning, the inter-skill policy can make real-time decisions about skill chaining, allowing the robot to adapt to unforeseen changes in the task requirements.

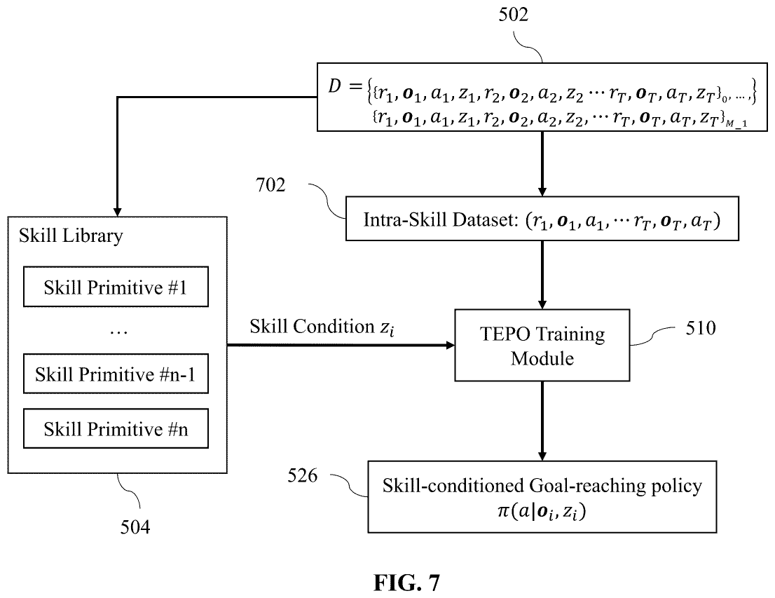

Referring to FIG. 5A and FIG. 7, the Tactile Ensemble Policy Optimization module 510 in the TEST framework is designed to learn a skill-conditioned goal-reaching policy 526 π(α|o,g,z), where the goal is implicitly induced by g={s|β_{z}(s)=1}. Without loss of generality, the expression π(α|o,g,z)≙(α|o,z) still applies. The action distribution may be parametrized by the output logits as follows:

$${π}_{θ} ( a \vert o , z ) = 𝒩 ( {μ}_{θ} ( o , z ) , {\sum }_{θ} ( o , z ) ) . \qquad ( 6 )$$

Intuitively, TEPO 510 learns a goal-reaching policy at the sub-skill level. Although the horizon is significantly shortened compared to directly learning over the entire horizon of tasks, the rewards could still be sparse, being provided only when the exact goal is achieved. This sparsity can adversely affect learning, especially in offline settings where the robot cannot interact with the environment to gather more data. Therefore, some embodiments conduct an additional goal relabeling strategy for TEPO training.

For the input sub-skill trajectory τₖ corresponding to zₖ introduced in (1), the original g∈{s|β_{z}_{ₖ}(s)=1}. The goal states are resampled from those in trajectories τₖ,

$$GoalRelabeling : {g}^{′} ∼ {p}_{s} ( {τ}_{k} ) \qquad ( 7 )$$

$$RewardRelabeling : {r}_{t ′} = r ( s , {g}^{′} ; {z}_{k} ) ,$$

where pₛ(·) is the empirical marginal state distribution of the input trajectories. After the hindsight relabeling, multiple relabeled trajectories τ_{k′}={oₒ,α₀,r₀,s₁, . . . ,o_{T-1},α_{T-1},r_{T-1}′;g′} can be generated, which diversifies the step reward, and corresponding reward-to-go predictions for identical historical sequences, improving goal scenario generalization.

After the data augmentation with hindsight relabeling, the augmented trajectories s are obtained. Given the offline demonstration, TEPO 510 aims to minimize the following negative log-likelihood loss with an entropy regularizer:

$${ℒ}_{TEPO} = {𝔼}_{{τ}_{z} ∼ {π}_{0}^{z}} [ - log {π}_{ϕ} ( a \vert o , z ) - λ H [ {π}_{ϕ} ( \cdot \vert o , z ) ] ] . \qquad ( 8 )$$

where λ is the weight of the regularizer. By leveraging goal-conditioned trajectory optimization, this policy focuses on achieving a specific target goal space within a given skill. The policy takes into account both the current state of the robot and the desired end state or goal. Through a combination of tactile feedback and ensemble learning, the intra-skill policy optimizes the trajectory in real time, ensuring that the robot can adapt to changes and uncertainties in the environment. This adaptability is crucial for tasks that require fine motor skills, such as aligning parts in an assembly with tight tolerances.

As illustrated in FIG. 7, the randomly sampled demonstration data 502 is utilized to build a library of skills 504. Assume n skill primitives and denoting a skill set as

$${\{ {z}^{( i )} \}}_{i = 1}^{N} ,$$

a skill-labeled offline dataset may be given by some heuristic behavior policy π₀⁽ⁱ⁾ 207, where (i) refers to the skill index of z. The step reward r, the observations o, and the corresponding actions a of the demonstration data 502 form the intra-skill dataset 702. Skill conditions from the skill library 504 and the intra-skill dataset 702 are provided as training inputs to the TEPO training module 510 to obtain a skill-conditioned goal-reaching policy 526.

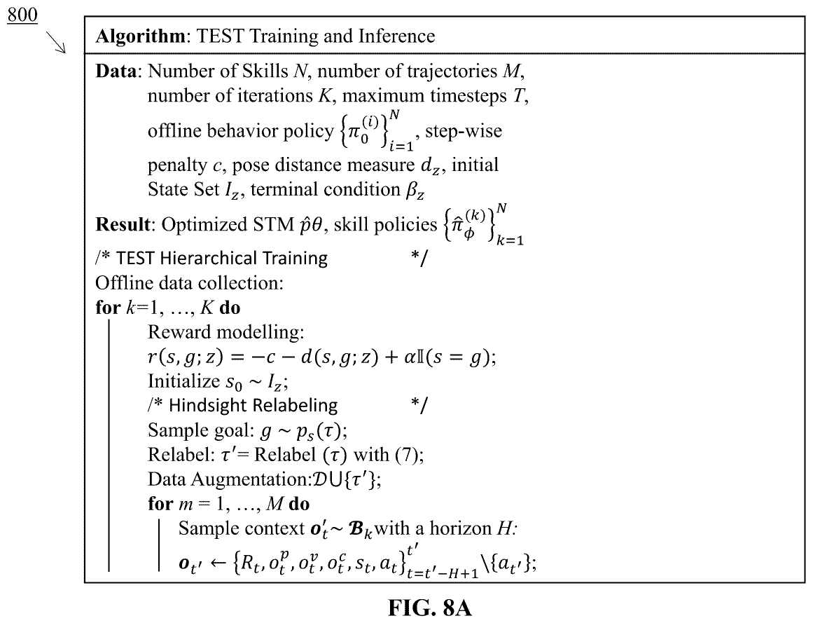

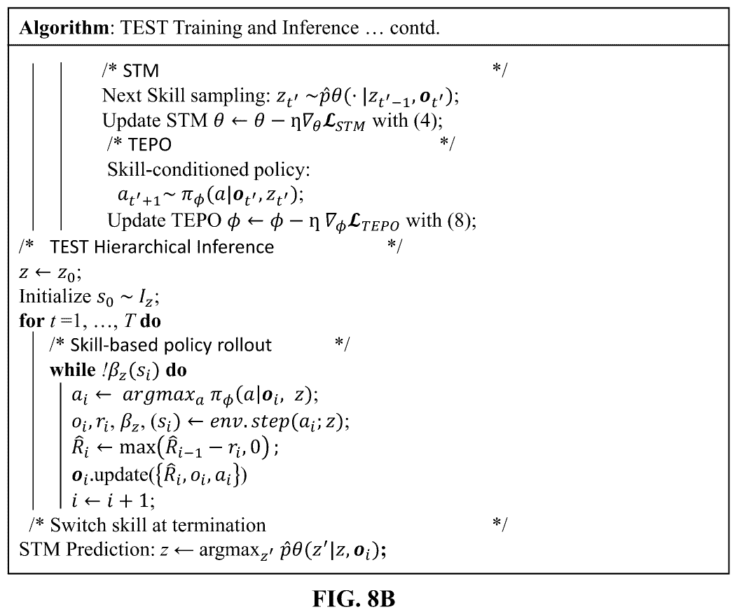

The training pipeline is summarized as a pseudocode in the algorithm jointly illustrated in FIGS. 8A and 8B. After the TEST model 106C is trained with STM 508 and TEPO 510 in an alternative optimization, some embodiments apply hierarchical inference at the online deployment stage to further improve the performance of TEST. As illustrated in the algorithm of FIGS. 8A and 8B, TEST conducts hierarchical inference between the goal-reaching sub-skill policies and skill transition model.

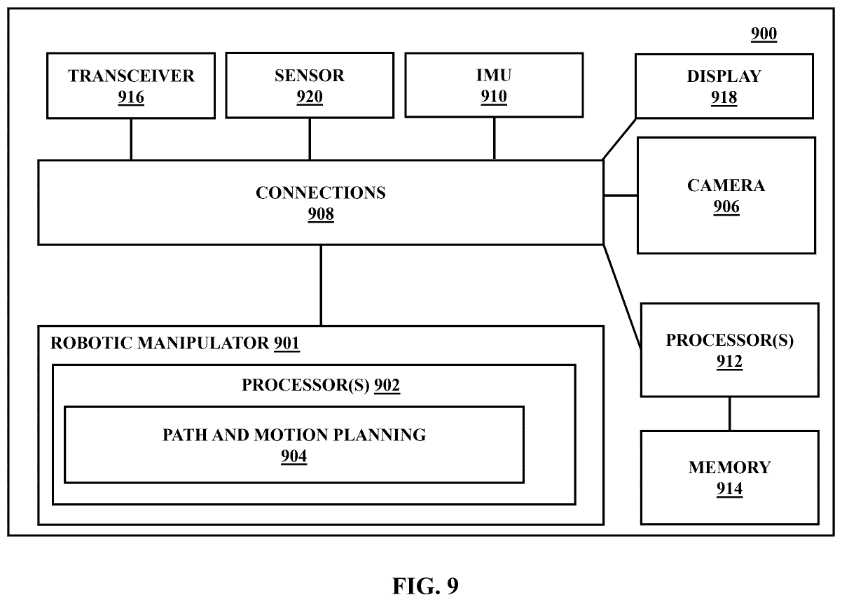

FIG. 9 illustrates some components of a control system 900 for controlling a robotic manipulator 901 according to a task, according to some embodiments. The control system 900 comprises communication interfaces such as a transceiver 916, sensors 920, input interface such as an inertial measurement unit (IMU) 910, output interfaces such as a display 918, one or more visual sensors such as a camera 906, computational circuitry realized through one or more processors 912 and memory 914. One or more connection buses 908 may couple the components of the control system 900 with each other. According to some embodiments, the engineering system 900 may also be coupled with a robotic manipulator 901. The robotic manipulator 901 comprises suitable processing circuitry realized through processors 902 and memory that stores a path and motion planning module 904.

According to some embodiments, the modules described with reference to FIGS. 2A-9 may be executed by the processing/computation circuitry of the control system 900 to predict skills and actions conditioned upon the skills for controlling the robotic manipulator 901 in accordance with various embodiments described herein.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A feedback controller for controlling a robotic manipulator according to a task, the robotic manipulator includes one or more actuators operatively coupled to one or more joints of the robotic manipulator for moving an end effector, the feedback controller includes a circuitry configured to:
accept a feedback signal including a sequence of multi-modal observations of a state of execution of the task, wherein the multi-modal observations include measurements of one or more visuo-tactile sensors attached to the end effector, video frames of a camera observing the state of execution of the task, and proprioceptive measurements of one or more actuators;
process the multi-modal observations with a neural network having a self-attention module with a hierarchically conditioned output to produce a skill of the robotic manipulator and an action conditioned on the skill, wherein each skill defines a combination of actions, and wherein the neural network is trained in a supervised manner with demonstration data to produce a sequence of skills and a corresponding sequence of actions for the actuators of the robotic manipulator to perform the task;
determine one or more control commands for the one or more actuators based on the produced action; and
submit the one or more control commands to the one or more actuators causing a change of the state of execution of the task.

2. The feedback controller of claim 1, wherein to perform the control step, the feedback controller is configured to:
update the sequence of actions with the current action and update the sequence of skills with the current skill.

3. The feedback controller of claim 1, wherein the multi-modal observations are processed in an iterative manner, and wherein the multi-modal observations in a current iteration correspond to state change of the robotic manipulator caused by the control commands executed in a previous iteration.

4. The feedback controller of claim 1, wherein the circuitry is further configured to encode each observation of the multimodal observations into an embedding of the observation in a latent space.

5. The feedback controller of claim 1, wherein the multi-modal observations are processed in an iterative manner, and the circuitry is configured to execute a reward function conditioned upon a goal, to terminate an iteration of the processing of the multi-modal observations marking completion of the task.

6. The feedback controller of claim 5, wherein the reward function is modeled based on a negative distance to the goal and an indication function of reaching the goal.

7. The feedback controller of claim 1, wherein the architecture of the neural network comprises a high-level planner configured to predict a skill based on the feedback signal and a low-level goal reaching module configured to output an action conditioned upon the predicted skill.

8. A method for controlling a robotic manipulator according to a task, comprising:
accepting a feedback signal including a sequence of multi-modal observations of a state of execution of the task, wherein the multi-modal observations include measurements of one or more visuo-tactile sensors attached to an end effector of the robotic manipulator, video frames of a camera observing the state of execution of the task, and proprioceptive measurements of one or more actuators of the robotic manipulator;
processing the multi-modal observations with a neural network having a self-attention module with a hierarchically conditioned output to produce a skill of the robotic manipulator and an action conditioned on the skill, wherein each skill defines a combination of actions, and wherein the neural network is trained in a supervised manner with demonstration data to produce a sequence of skills and a corresponding sequence of actions for the actuators of the robotic manipulator to perform the task;
determining one or more control commands for the one or more actuators based on the produced action; and
submitting the one or more control commands to the one or more actuators causing a change of the state of execution of the task.

9. The method of claim 8, further comprising:
updating the sequence of actions with the current action and updating the sequence of skills with the current skill.

10. The method of claim 8, wherein the multi-modal observations are processed in an iterative manner, and wherein the multi-modal observations in a current iteration correspond to state change of the robotic manipulator caused by the control commands executed in a previous iteration.

11. The method of claim 8, further comprising encoding each observation of the multimodal observations into an embedding of the observation in a latent space.

12. The method of claim 8, wherein the multi-modal observations are processed in an iterative manner, and the method further comprises executing a reward function conditioned upon a goal, to terminate an iteration of the processing of the multi-modal observations marking completion of the task.

13. The method of claim 12, wherein the reward function is modeled based on a negative distance to the goal and an indication function of reaching the goal.

14. The method of claim 8, wherein the architecture of the neural network comprises a high-level planner configured to predict a skill based on the feedback signal and a low-level goal reaching module configured to output an action conditioned upon the predicted skill.

15. A non-transitory computer readable medium having stored thereon instructions that when executed by a computer, cause the computer to perform a method for controlling a robotic manipulator according to a task, the method comprising:
accepting a feedback signal including a sequence of multi-modal observations of a state of execution of the task, wherein the multi-modal observations include measurements of one or more visuo-tactile sensors attached to an end effector of the robotic manipulator, video frames of a camera observing the state of execution of the task, and proprioceptive measurements of one or more actuators of the robotic manipulator;
processing the multi-modal observations with a neural network having a self-attention module with a hierarchically conditioned output to produce a skill of the robotic manipulator and an action conditioned on the skill, wherein each skill defines a combination of actions, and wherein the neural network is trained in a supervised manner with demonstration data to produce a sequence of skills and a corresponding sequence of actions for the actuators of the robotic manipulator to perform the task;
determining one or more control commands for the one or more actuators based on the produced action; and
submitting the one or more control commands to the one or more actuators causing a change of the state of execution of the task.

16. The non-transitory computer readable medium of claim 15, wherein the method further comprises:
updating the sequence of actions with the current action and updating the sequence of skills with the current skill.

17. The non-transitory computer readable medium of claim 15, wherein the multi-modal observations are processed in an iterative manner, and wherein the multi-modal observations in a current iteration correspond to state change of the robotic manipulator caused by the control commands executed in a previous iteration.

18. The non-transitory computer readable medium of claim 15, wherein the method further comprises encoding each observation of the multimodal observations into an embedding of the observation in a latent space.

19. The non-transitory computer readable medium of claim 15, wherein the multi-modal observations are processed in an iterative manner, and the method further comprises executing a reward function conditioned upon a goal, to terminate an iteration of the processing of the multi-modal observations marking completion of the task.

20. The non-transitory computer readable medium of claim 19, wherein the reward function is modeled based on a negative distance to the goal and an indication function of reaching the goal.
